(19) United States
(12) Patent Application Publication
(10) Pub. No.: US 2009/0197573 A1
(43) Pub. Date: Aug. 6, 2009

(54) SECURE USE OF A HANDHELD COMPUTING UNIT

(75) Inventor: AHMADREZA REZA ROFOUGARAN, Newport Coast, CA (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 12/393,421

(22) Filed: Feb. 26, 2009

Related U.S. Application Data
(63) Continuation-in-part of application No. 12/026,681, filed on Feb. 6, 2008.

(51) Int. Cl. H04W 12/00; H04L 9/32; G06F 21/00; G06F 9/00

(52) U.S. Cl. 455/411; 726/19; 713/168

(57) ABSTRACT

A handheld computing unit includes a wireless transceiver and a processing module. The processing module is coupled to detect initiation of use of the handheld computing unit. When the initiation of use is detected, the processing module initiates collection of a user security parameter; receives an input corresponding to the user security parameter; and converts the input into the outbound symbol stream. The wireless transceiver converts outbound symbol stream into an outbound wireless signal and transmits it. The wireless transceiver also receives an inbound wireless signal and converts it into an inbound symbol stream. The processing module converts the inbound symbol stream into a security response; interprets the security response; and, when the security response is favorable, enables use of the handheld computing unit.

This patent application is claiming priority under 35 USC §120 as a continuation in part patent application of co-pending patent application entitled COMPUTING DEVICE WITH HANDHELD AND EXTENDED COMPUTING UNITS, having a filing date of Feb. 6, 2008.

### STATEMENT REGARDING FEDERALLY SPONSORED RESEARCH OR DEVELOPMENT

NOT APPLICABLE

### INCORPORATION-BY-REFERENCE OF MATERIAL SUBMITTED ON A COMPACT DISC

NOT APPLICABLE

### BACKGROUND OF THE INVENTION

1. Technical Field of the Invention

This invention relates generally to communication systems and more particularly to computing devices used in such communication systems.

2. Description of Related Art

Communication systems are known to support wireless and wire lined communications between wireless and/or wire lined communication devices. Such communication systems range from national and/or international cellular telephone systems to the Internet to point-to-point in-home wireless or wired networks. The wireless and/or wire lined communication devices may be personal computers, laptop computers, personal digital assistants (PDA), cellular telephones, personal digital video players, personal digital audio players, global positioning system (GPS) receivers, video game consoles, entertainment devices, etc.

Many of the communication devices include a similar basic architecture: that being a processing core, memory, and peripheral devices. In general, the memory stores operating instructions that the processing core uses to generate data, which may also be stored in the memory. The peripheral devices allow a user of the communication device to direct the processing core as to which operating instructions to execute, to enter data, etc. and to see the resulting data. For example, a personal computer includes a keyboard, a mouse, and a display, which a user uses to cause the processing core to execute one or more of a plurality of applications.

While the various communication devices have a similar basic architecture, they each have their own processing core, memory, and peripheral devices and provide distinctly different functions. For example, a cellular telephone is designed to provide wireless voice and/or data communications in accordance with one or more wireless communication standards (e.g., IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), radio frequency identification (RFID), Enhanced Data rates for GSM Evolution (EDGE), General Packet Radio Service (GPRS), and/or variations thereof). As another example, a personal digital audio player is designed to decompress a stored digital audio file and render the decompressed digital audio file audible.

Over the past few years, integration of the some of the communication device functions into a single device has occurred. For example, many cellular telephones now offer personal digital audio playback functions, PDA functions, and/or GPS receiver functions. Typically, to load one or more of these functions, files, or other applications onto a handheld communication device (e.g., a cellular telephone, a personal digital audio and/or video player, a PDA, a GPS receiver), the handheld communication device needs to be coupled to a personal computer or laptop computer. In this instance, the desired application, function, and/or file is first loaded on to the computer and then copied to the handheld communication device; resulting in two copies of the application, function, and/or file.

To facilitate such loading of the application, function, and/or file in this manner, the handheld communication device and the computer each require hardware and corresponding software to transfer the application, function, and/or file from the computer to the handheld communication device. As such, two copies of the corresponding software exist as well as having two hardware components (one for the handheld device and the second for the computer). In addition to the redundancy of software, timing issues, different versions of the software, incompatible hardware, and a plethora of other reasons cause the transfer of the application, function, and/or file to fail.

In addition to integration of some functions into a single handheld device, handheld digital audio players may be docked into a speaker system to provide audible signals via the speakers as opposed to a headphone. Similarly, a laptop computer may be docked to provide connection to a full size keyboard, a separate monitor, a printer, and a mouse. In each of these docking systems, the core architecture is not changed.

With increasing integration of multiple functions into a handheld device, secure use of the handheld device of increased importance. For instance, with contact information, music files, etc. stored on the handheld device, it is desirable only enable an authorized user of the device to access such files, to place cellular telephone calls, and/or access web browsers.

Therefore, a need exists for a computing device that includes a handheld computing unit and an extended computing unit, wherein use of the handheld computing unit is done in a secure manner.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a diagram of an embodiment of a handheld computing unit and an extended computing unit in accordance with the present invention;

FIG. 2 is a schematic block diagram of an embodiment of a handheld computing unit docked to an extended computing unit within a communication system in accordance with the present invention;

FIG. 3 is a schematic block diagram of an embodiment of a handheld computing unit quasi docked to an extended computing unit within a communication system in accordance with the present invention;

FIG. 4 is a schematic block diagram of an embodiment of a handheld computing unit in a remote mode with respect to an extended computing unit within a communication system in accordance with the present invention;

FIG. 5 is a schematic block diagram of an embodiment of a handheld computing unit communicating with an extended computing unit or a security access computer in accordance with the present invention;

FIG. 6 is a schematic block diagram of another embodiment of a handheld computing unit communicating with an extended computing unit or a security access computer in accordance with the present invention;

FIG. 7 is a logic diagram of an embodiment of a method for establishing secure use of a handheld computing unit in accordance with the present invention;

FIG. 8 is a logic diagram of another embodiment of a method for establishing secure use of a handheld computing unit in accordance with the present invention; and

FIG. 9 is a logic diagram of another embodiment of a method for establishing secure use of a handheld computing unit in accordance with the present invention.

### DETAILED DESCRIPTION OF THE INVENTION

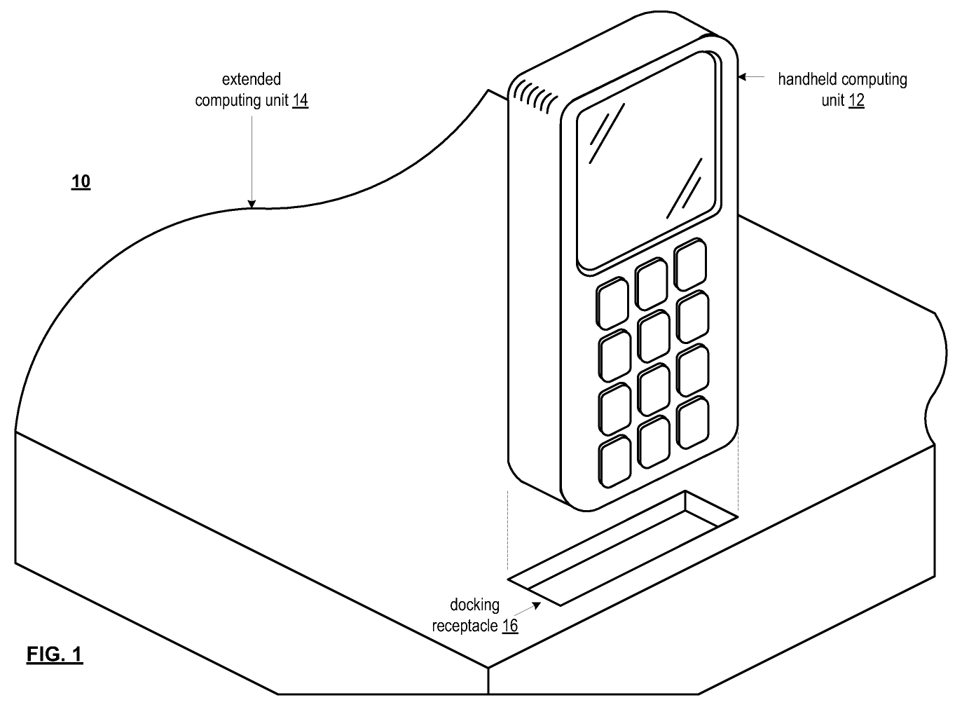

FIG. 1 is a diagram of an embodiment of a computing device 10 that includes a handheld computing unit 12 and an extended computing unit 14. The handheld computing unit 12 may have a form factor similar to a cellular telephone, personal digital assistant, personal digital audio/video player, etc. and includes a connector structure that couples to a docketing receptacle 16 of the extended computing unit 14.

In general, the handheld computing unit 12 includes the primary processing module (e.g., central processing unit), the primary main memory, and the primary hard disk memory for the computing device 10. In this manner, the handheld computing unit 12 functions as the core of a personal computer (PC) or laptop computer when it is docked to the extended computing unit and functions as a cellular telephone, a GPS receiver, a personal digital audio player, a personal digital video player, a personal digital assistant, and/or other handheld electronic device when it is not docked to the extended computing unit.

In addition, when the handheld computing unit 12 is docked to the extended computing unit 14, files and/or applications can be swapped therebetween. For example, assume that the user of the computing device 10 has created a presentation using presentation software and both reside in memory of the extended computing unit 14. The user may elect to transfer the presentation file and the presentation software to memory of the handheld computing unit 12. If the handheld computing unit 12 has sufficient memory to store the presentation file and application, then it is copied from the extended computing unit memory to the handheld computing unit memory. If there is not sufficient memory in the handheld computing unit, the user may transfer an application and/or file from the handheld computing unit memory to the extended computing unit memory to make room for the presentation file and application.

With the handheld computing unit 12 including the primary components for the computing device 10, there is only one copy of an application and/or of a file to support PC functionality, laptop functionality, and a plurality of handheld device functionality (e.g., TV, digital audio/video player, cell phone, PDA, GPS receiver, etc.). In addition, since only one copy of an application and/or of a file exists (other than desired backups), special software to transfer the applications and/or files from a PC to a handheld device is no longer needed. As such, the processing module, main memory, and I/O interfaces of the handheld computing unit 12 provide a single core architecture for a PC and/or a laptop, a cellular telephone, a PDA, a GPS receiver, a personal digital audio player, a personal digital video player, etc.

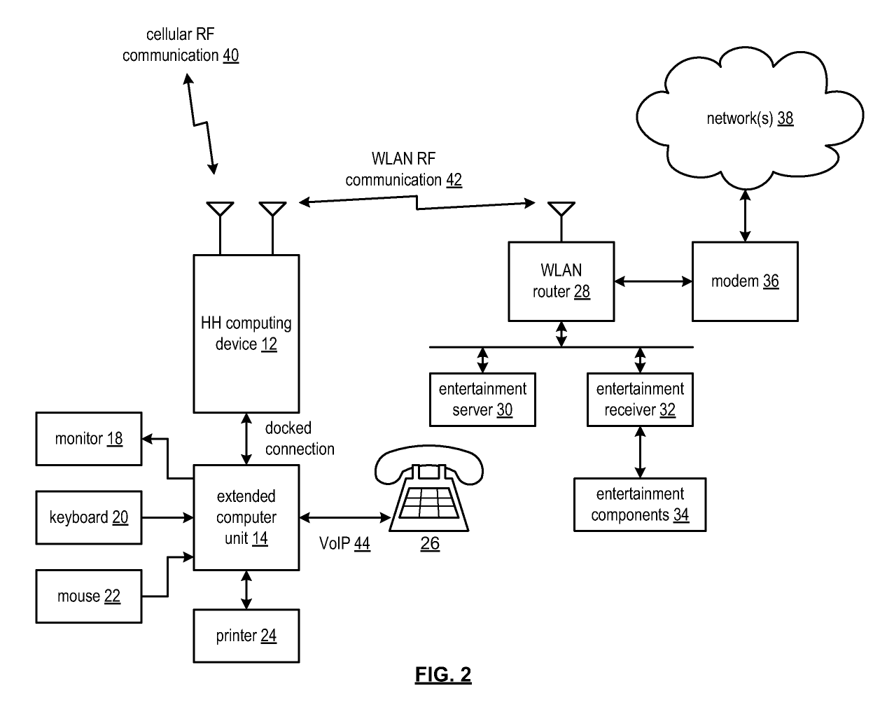

FIG. 2 is a schematic block diagram of an embodiment of a handheld computing unit 12 docked to an extended computing unit 14 within a communication system. In this embodiment, the communication system may include one or more of a wireless local area network (WLAN) router 28, a modem 36 coupled to the one or more networks 38 (e.g., a wireless local area network, a wide area network, the internet, the public switch telephone network, etc.), an entertainment server 30 (e.g., a server coupled to database of movies, music, video games, etc.), an entertainment receiver 32, entertainment components 34 (e.g., speaker system, television monitor and/or projector, DVD (digital video disc) player or newer versions thereof, VCR (video cassette recorder), satellite set top box, cable set top box, video game console, etc.), and a voice over internet protocol (VoIP) phone 26. As an alternative or in addition to the WLAN router 28, the system may include a local area network (LAN) router coupled to the extended computing unit 14.

As is also shown, the extended computing unit 14 is coupled to a monitor 18, a keyboard, a mouse 22, and a printer 24. The extended computing unit 14 may also be coupled to other devices (not shown) such as a trackball, touch screen, gaming devices (e.g., joystick, game pad, game controller, etc.), an image scanner, a webcam, a microphone, speakers, and/or a headset. In addition, the extended computing unit 14 may have a form factor similar to a personal computer and/or a laptop computer. For example, for in-home or in-office use, having the extended computing unit with a form factor similar to a PC may be desirable. As another example, for traveling users, it may be more desirable to have a laptop form factor.

In this example, the handheld computing unit 12 is docked to the extended computer unit 14 and function together to provide the computing device 10. The docking of the handheld computing unit 12 to the extended computing unit 14 encompasses one or more high speed connections between the units 12 and 14. Such a high speed connection may be provided by an electrical connector, by an RF connector, by an electromagnetic connector, and/or a combination thereof. In this mode, the handheld computing unit 12 and the extended computing 14 collectively function similarly to a personal computer and/or laptop computer with a WLAN card and a cellular telephone card.

In this mode, the handheld computing unit 12 may transceive cellular RF communications 40 (e.g., voice and/or data communications). Outgoing voice signals may originate at the VoIP phone 26 as part of a VoIP communication 44 or a microphone coupled to the extended computing unit 14. The outgoing voice signals are converted into digital signals that are subsequently converted to outbound RF signals. Inbound RF signals are converted into incoming digital audio signals and that may be provided to a sound card within the extended computing unit for presentation on speakers or provided to the VoIP phone via as part of a VoIP communication 44.

Outgoing data signals may originate at the mouse 22, keyboard 20, image scanner, etc. coupled to the extended computing unit 14. The outgoing data signals are converted into digital signals that are subsequently converted to outbound RF signals. Inbound RF signals are converted into incoming data signals and that may be provided to the monitor 18, the printer 24, and/or other character presentation device.

In addition, the handheld computing unit 12 may provide a WLAN transceiver for coupling to the WLAN router 28 to support WLAN RF communications 42 for the computing device 10. The WLAN communications 42 may be for accessing the internet 38 via modem 36, for accessing the entertainment server, and/or accessing the entertainment receiver 32. For example, the WLAN communications 42 may be used to support surfing the web, receiving emails, transmitting emails, accessing on-line accounts, accessing on-line games, accessing on-line user files (e.g., databases, backup files, etc.), downloading music files, downloading video files, downloading software, etc. As another example, the computing device 10 (i.e., the handheld computing unit 12 and the extended computing unit 14) may use the WLAN communications 42 to retrieve and/or store music and/or video files on the entertainment server; and/or to access one or more of the entertainment components 34 and/or the entertainment receiver 32.

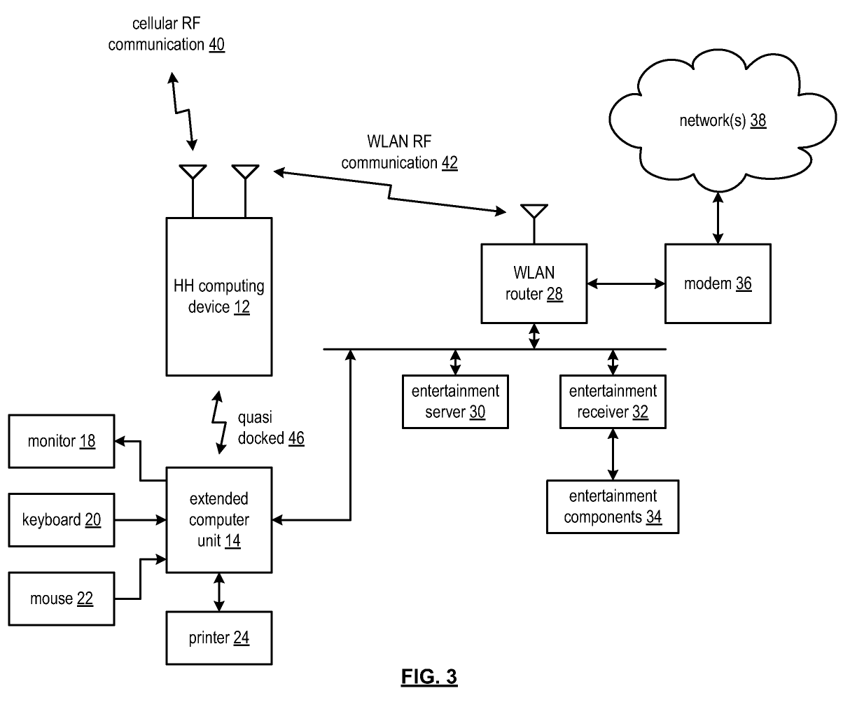

FIG. 3 is a schematic block diagram of an embodiment of a handheld computing unit 12 quasi docked to an extended computing unit 14 within a communication system. In this embodiment, the communication system may include one or more of a wireless local area network (WLAN) router 28, a modem 36 coupled to the internet 38, an entertainment server 30 (e.g., a server coupled to database of movies, music, video games, etc.), an entertainment receiver 32, entertainment components 34 (e.g., speaker system, television monitor and/or projector, DVD (digital video disc) player or newer versions thereof, VCR (video cassette recorder), satellite set top box, cable set top box, video game console, etc.), and a voice over internet protocol (VoIP) phone 26. As an alternative or in addition to the WLAN router 28, the system may include a local area network (LAN) router coupled to the extended computing unit 14.

As is also shown, the extended computing unit 14 is coupled to a monitor 18, a keyboard, a mouse 22, and a printer 24. The extended computing unit 14 may also be coupled to other devices (not shown) such as a trackball, touch screen, gaming devices (e.g., joystick, game pad, game controller, etc.), an image scanner, a webcam, a microphone, speakers, and/or a headset. In addition, the extended computing unit 14 may have a form factor similar to a personal computer and/or a laptop computer.

In this example, the handheld computing unit 12 is quasi docked 46 to the extended computer unit 14, where the handheld computing unit 12 functions as a stand-alone computer with limited resources (e.g., processing modules, user inputs/outputs, main memory, etc. of the handheld computing unit) and limited access to the memory of the extended computing unit 14. The quasi docking 46 of the handheld computing unit 12 to the extended computing unit 14 is provided by an RF communication, where an RF transceiver of the handheld computing unit 12 is communicating with an RF transceiver of the extended computing unit 14. Depending on the bit rate of the RF connection, the handheld computing unit can access files and/or applications stored in memory of the extended computing unit 14. In addition, the handheld computing unit 12 may direct the processing module of the extended computing unit 14 to perform a remote co-processing function, but the processing module of the handheld computing unit and the extended computing unit do not function as a multiprocessing module as they do when in the docked mode.

As an alternative, the quasi docked mode may be achieved by the handheld computing unit 12 communicating with the extended computing unit via the WLAN communication 42 and the WLAN router 28. As yet another example, the quasi docked mode may be achieved via a data cellular RF communication 40 via the network(s) 38 to the extended computing unit 14.

In this mode, the handheld computing unit 12 may transceive cellular RF communications 40 (e.g., voice and/or data communications). Outgoing voice signals originate at a microphone of the handheld computing unit 12. The outgoing voice signals are converted into digital signals that are subsequently converted to outbound RF signals. Inbound RF signals are converted into incoming digital audio signals and that are provided to a speaker, or headphone jack, of the handheld computing unit 12.

Outgoing data signals originate at a keypad or touch screen of the handheld computing unit 12. The outgoing data signals are converted into digital signals that are subsequently converted to outbound RF signals. Inbound RF signals are converted into incoming data signals that are provided to the handheld display and/or other handheld character presentation device.

In addition, the handheld computing unit 12 may provide a WLAN transceiver for coupling to the WLAN router 28 to support WLAN RF communications 42 with the WLAN router 28. The WLAN communications 42 may be for accessing the internet 38 via modem 36, for accessing the entertainment server, and/or accessing the entertainment receiver 32. For example, the WLAN communications 42 may be used to support surfing the web, receiving emails, transmitting emails, accessing on-line accounts, accessing on-line games, accessing on-line user files (e.g., databases, backup files, etc.), downloading music files, downloading video files, downloading software, etc. As another example, the handheld computing unit 12 may use the WLAN communications 42 to retrieve and/or store music and/or video files on the entertainment server; and/or to access one or more of the entertainment components 34 and/or the entertainment receiver 32.

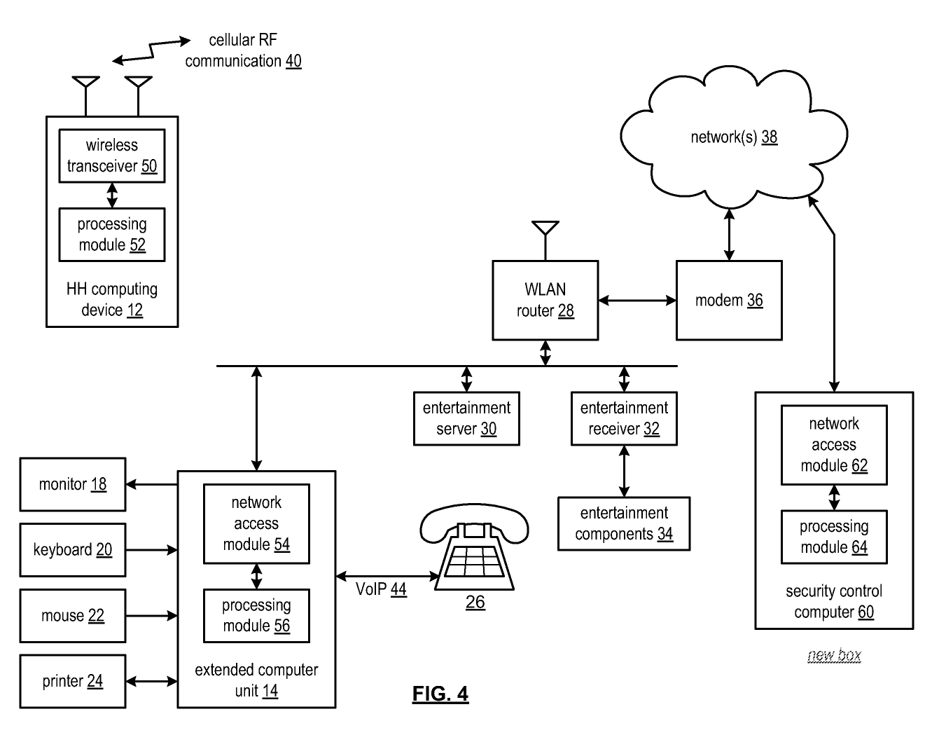

FIG. 4 is a schematic block diagram of an embodiment of a handheld computing unit 12 in a remote mode with respect to an extended computing unit 14. In this illustration, each of the handheld computing 12, the extended computing unit 14, and the security access computer 60 includes a processing module 52, 56, and 64. The handheld computing unit 12 includes a wireless transceiver 50 and each of the extended computing unit 14 and the security control computer 60 includes a network access module 54 and 62. The processing module may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module may have an associated memory and/or memory element, which may be a single memory device, a plurality of memory devices, and/or embedded circuitry of the processing module. Such a memory device may be a read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Further note that, the memory element stores, and the processing module executes, hard coded and/or operational instructions corresponding to at least some of the steps and/or functions illustrated in FIGS. 1-9.

In this mode, the handheld computing unit 12 has limited communications with the extended computing unit 14. As such, the extended computing unit 14 is substantially disabled and the handheld computing unit 12 functions as a stand-alone computing device. Nevertheless, the handheld computing unit 12 accesses the extended computer 14 to retrieve security permissions to enable full or partial use of the handheld computing unit 12. Alternatively, the handheld computing unit 12 may access a security control computer 60 to retrieve the security permissions. In either case, all features or some of them are blocked until a security permission is received from the extended computing unit 14 or the security control computer 60. In this manner, secure use of the handheld computing unit is insured by the pairing nature of the handheld computing unit 12 with the extended computing unit 14, or with a security control computer 60.

The security control computer 60 may be a computer controlled by a company such that its employees use of company issued handheld computing units retrieve the security permissions from the security control computer 60. Alternatively, the security control computer 60 may be operated by a third party to provide an additional level of security for use on any handheld device that has a wireless transceiver.

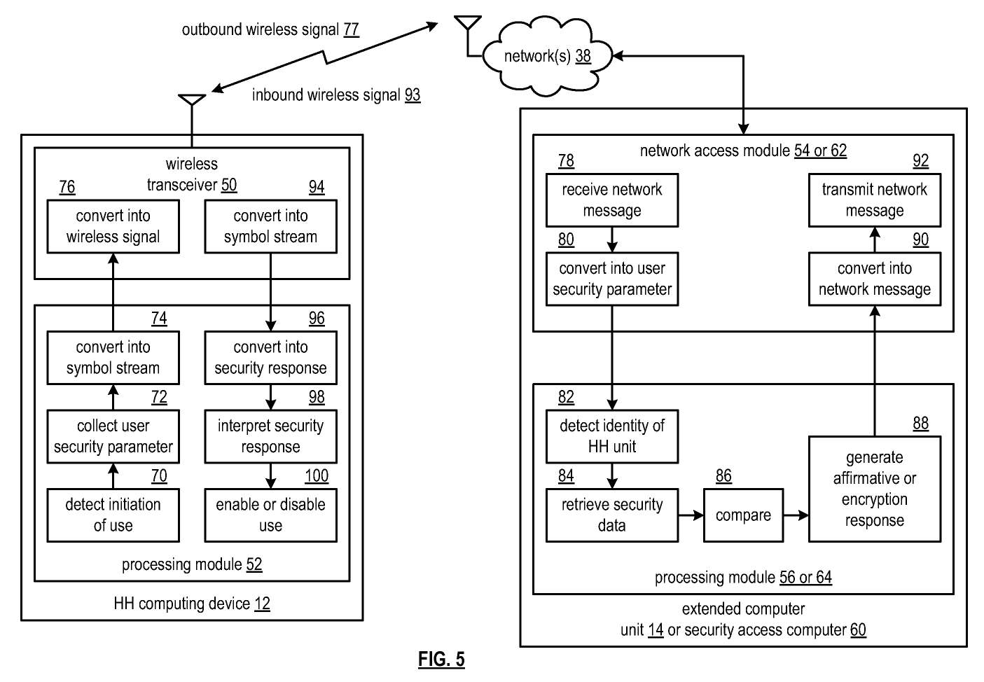

FIG. 5 is a schematic block diagram of an embodiment of a handheld computing unit 12 communicating with an extended computing unit 14 or a security access computer 60. The handheld computing unit 12 includes the wireless transceiver 50 and the processing module 52. The extended computing unit 14 or the security access computer 60 includes a network access module 54 or 62 and a processing module 56 or 64. Note that the wireless transceiver 50 and the processing module 52 of the handheld computing unit 12 may be implemented on one or more integrated circuits. Further note that the network access module 54 and the processing module 56 of the extended computing unit 14 may be implemented on one or more integrated circuits.

In an example of operation, the processing module 52 detects, at function block 70, initiation of use of the handheld computing unit 12. This may be done by detecting one or more of initiation of a cellular telephone call, initiation of a text message, initiation of a digital image capture (e.g., a digital picture or digital movie), initiation of audio capture (e.g., storing an audio file, dictation, etc.), initiation of a web browser access request, initiation of a data access request (e.g., access to contact list, a program, a video file, an audio file, etc.), initiation of an audio file playback, initiation of a video file playback, and initiation of a user application.

When initiation of use is detected, the processing module 52 collects, at function block 72, one or more user security parameters. This may be done by initiating collection of a user security parameter and receiving an input corresponding to the user security parameter. For example, the user security parameter may be collected automatically (e.g., take a digital photo, a finger print, etc.) upon detection of initiation of use or by providing a graphic user interface for inputting the user security parameter. In either case, the user security parameter may be a password, a video image, a finger print, a voice sample, and/or a security phrase (e.g., Hal, please engage cellular telephone operation).

The processing module then converts, at function block 74, the input into the outbound symbol stream in accordance with a wireless communication standard (e.g., WCDMA, GSM, EDGE, GPRS, WLAN, etc.). Such a conversion includes one or more of: scrambling, puncturing, encoding, interleaving, constellation mapping, modulation, frequency spreading, frequency hopping, beamforming, space-time-block encoding, space-frequency-block encoding, frequency to time domain conversion, and/or digital baseband to intermediate frequency conversion. The processing module 52 provides the outbound symbol stream to the wireless transceiver 50.

The wireless transceiver 50 may be a radio frequency (RF) transceiver and/or a millimeter wave (MMW) transceiver and includes a transmitter section and a receiver section. In an embodiment, the transmitter section converts the outbound symbol stream into the wireless signal 77 that has a carrier frequency within a given frequency band (e.g., 900 MHz, 1800 MHz, 1900 MHz, 2.4 GHz, 5 GHz, 29 GHz, 57-66 GHz, etc.). This may be done by mixing the outbound symbol stream with a local oscillation to produce an up-converted signal. One or more power amplifiers and/or power amplifier drivers amplifies the up-converted signal, which may be RF or MMW bandpass filtered, to produce the wireless signal. In another embodiment, the transmitter section includes an oscillator that produces an oscillation. The outbound symbol stream provides phase information (e.g., ±Δθ [phase shift] and/or θ(t) [phase modulation]) that adjusts the phase of the oscillation to produce a phase adjusted RF or MMW signal, which is transmitted as the outbound wireless signal. In another embodiment, the outbound symbol stream includes amplitude information (e.g., A(t) [amplitude modulation]), which is used to adjust the amplitude of the phase adjusted RF or MMW signal to produce the outbound wireless signal.

In yet another embodiment, the transmitter section includes an oscillator that produces an oscillation. The outbound symbol provides frequency information (e.g., ±Δf [frequency shift] and/or f(t) [frequency modulation]) that adjusts the frequency of the oscillation to produce a frequency adjusted RF or MMW signal, which is transmitted as the outbound wireless signal. In another embodiment, the outbound symbol stream includes amplitude information, which is used to adjust the amplitude of the frequency adjusted RF or MMW signal to produce the outbound wireless signal. In a further embodiment, the transmitter section includes an oscillator that produces an oscillation. The outbound symbol provides amplitude information (e.g., ±ΔA [amplitude shift] and/or A(t) [amplitude modulation) that adjusts the amplitude of the oscillation to produce the outbound wireless signal.

The extended computing unit 14 or the security access computer 60 receives the outbound wireless signal 77 via its network access module 54 or 62. The network access module may be network card, a wireless transceiver similar to wireless transceiver 50, or other network interface. At function block 78, the network access module 54 receives an inbound network message (e.g., the outbound wireless signal or a packetized representation thereof). At function block 80, the network access module 54 converts the inbound network message into a user security parameter (e.g., recovers the message from the wireless signal or the packetized representation thereof). Recall that a user security parameter may be a password, a video image, a finger print, a voice sample, and/or a security phrase.

The processing module 56, at function block 82, detects identity of a handheld computing unit initiating the inbound network message (e.g., from the message determines the identification code of the handheld computing unit). The processing module 82, at function block 84, retrieves security data of the handheld computing unit to produced retrieved security data. The security data is retrieved from secure memory within the extended computing unit 14 or the security access computer 60 and contains correlating data to that of valid user security parameters.

In an alternative embodiment, the network access module converts the inbound network message into the user security parameter and a type of use (e.g., cellular telephone call, text message, digital image capture, etc.). In this instance, the processing module 56 retrieves the security data of the handheld computing unit based on the type of use.

In either embodiment, the processing module, at function block 86, compares the user security parameter with the retrieved security data. When the user security parameter compares favorably with the retrieved security data, the processing module 56 generates an affirmative security response (e.g., a security code indicating that the security check passed, a particular encryption key to unlock functionality of the handheld device, etc.) If, however, the user security parameter compares unfavorably with the retrieved security data, the processing module generates an encryption command, such that user data of the handheld computing unit is encrypted locking it from being accessed by an unauthorized user.

The processing module 56 provides the affirmative response or the encryption command to the network access module 56, which converts the affirmative security response or the encryption command into an outbound network message at function block 90. The network access module 54, at function block 92 transmits the outbound network message via the networks 38 to the handheld computing unit 12.

The wireless transceiver 50 receives the inbound wireless signal 93 via the wireless communication resource and converts, at function block 94, the inbound wireless signal 93 into an inbound symbol stream. In an embodiment, a receiver section of the wireless transceiver 50 amplifies an inbound wireless signal to produce an amplified inbound RF signal. The receiver section may then mix in-phase (I) and quadrature (Q) components of the amplified inbound RF signal with in-phase and quadrature components of a local oscillation to produce a mixed I signal and a mixed Q signal. The mixed I and Q signals are combined to produce an inbound symbol stream. In this embodiment, the inbound symbol may include phase information (e.g., ±Δθ [phase shift] and/or θ(t) [phase modulation]) and/or frequency information (e.g., ±Δf [frequency shift] and/or f(t) [frequency modulation]). In another embodiment and/or in furtherance of the preceding embodiment, the inbound wireless signal includes amplitude information (e.g., ±ΔA [amplitude shift] and/or A(t) [amplitude modulation]). To recover the amplitude information, the receiver section includes an amplitude detector such as an envelope detector, a low pass filter, etc.

The processing module 52 converts, at function block 96, the inbound symbol stream into a security response in accordance with a wireless communication protocol. Such a conversion may include one or more of: digital intermediate frequency to baseband conversion, time to frequency domain conversion, space-time-block decoding, space-frequency-block decoding, demodulation, frequency spread decoding, frequency hopping decoding, beamforming decoding, constellation demapping, deinterleaving, decoding, depuncturing, and/or descrambling.

The processing module 52, at function block 98, interprets the security response (e.g., is it an affirmative response, an encryption response, a denial response, a request for a higher level user security parameter, etc.). When the security response is favorable (e.g., is the affirmative response), the processing module, at function block 100, enables use of the handheld computing unit. If the security response in not favorable, the processing module, at function block 100, disables the use of the handheld computing unit, at least for the requested use.

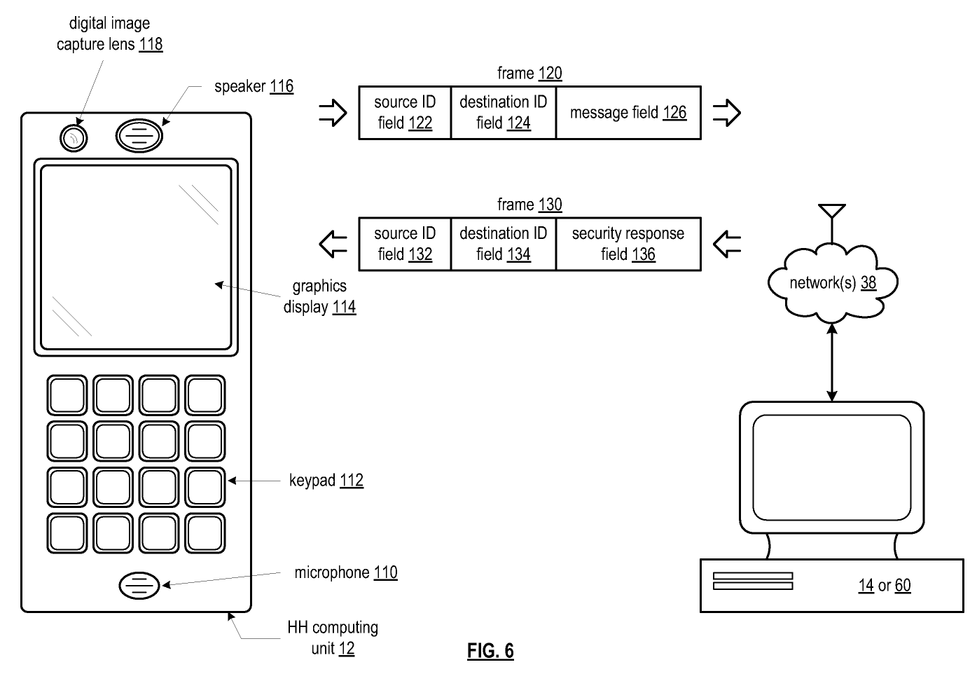

FIG. 6 is a schematic block diagram of another embodiment of a handheld computing unit 12 communicating with an extended computing unit 14 or a security access computer 60. In this embodiment, the handheld computing unit 12 includes a microphone 110, a keypad 112, a graphics display 114, a speaker 116, and a digital image capture lens 118 for capturing still or moving digital images. The handheld device 12 may further include a finger print reader (not shown).

In an example of operation, upon detection of use, the processing module 52 initiates collection of the user security parameter. This may be done automatically (e.g., taking a digital photo of the user, taking a finger print, etc.) or by providing a prompt on the graphics display 114. If the user security parameter is a voice print, the user speaks into the microphone. If the user security parameter is a password, the user enters it via the keypad and/or the graphics display 114. Numerous other mechanisms may be employed to capture the user security parameter.

Once the user security parameter is captured, the processing module generates a request message (e.g., places a cellular telephone call to the extended computing unit 14 or the security access computer or WLAN access request) to establish access to the wireless communication resource. The wireless transceiver 50 converts the request message into a wireless request signal and transmits it.

The wireless request signal may be structured as a frame or a packet 120. The frame 120 includes a source ID field 122, a destination ID field 124, and a message field 126. The source ID field 122 includes the identity of the handheld computing unit 12, which may be a cellular telephone number, an internet address, a security code, and/or a serial number. The destination ID field 124 includes the identity of the extended computing unit 14 or the security access computer 60, which may be a cellular telephone number, an internet address, a security code, and/or a serial number. The message field 126 includes a digital representation of the user security parameter.

After the extended computing unit 14 or the security access computer 60, which is functioning as a security repository, processes the user security parameter, it provides the response in a frame or packet 130. The frame or packet 130 includes a source ID field 132, a destination ID field 134, and a security response field 136. The source ID fields includes the identification of the extended computing unit 14 or the security access computer 60. The destination ID field 134 includes the identification of the handheld computing unit 12. The security response field 136 includes the affirmative response, the encryption response, the escalation response (e.g., provide a higher level user parameter), etc.

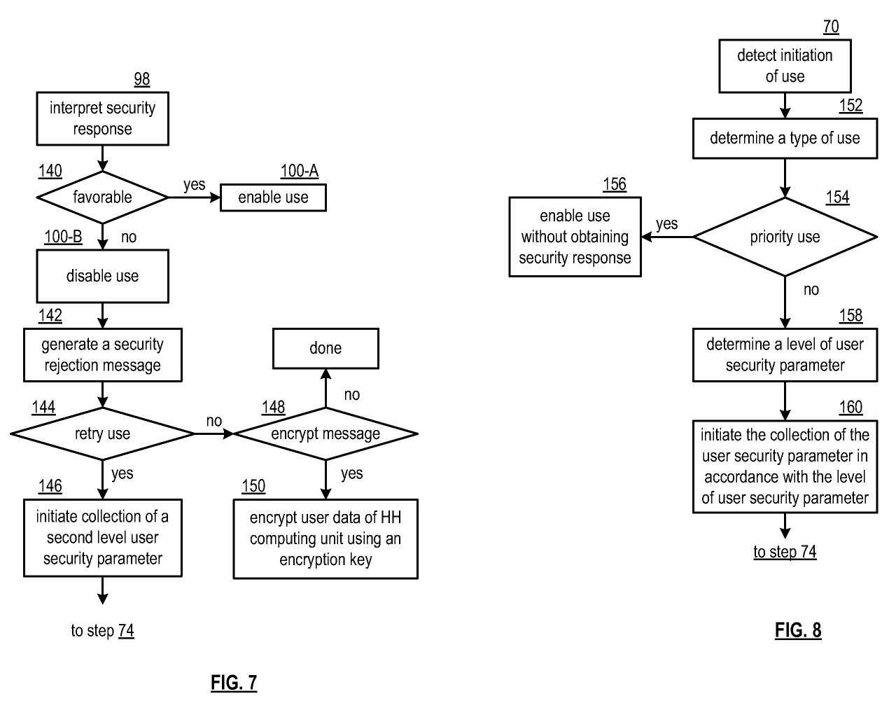

FIG. 7 is a logic diagram of an embodiment of a method for establishing secure use of a handheld computing unit that builds on function block 98. The method begins at step 140 where the processing module determines whether the security response was favorable. If the response was favorable (e.g., the affirmative response), the method continues at function block 100-A, where the processing module enables the use of the handheld computing unit 12. If, however, the response was not favorable (encryption message, denial message, escalation message, etc.), the method continues at function block 100-B where the processing module disables use of the handheld computing unit. In this instance, the processing module may disable the particular function attempting to be used (e.g., text messaging) or disable the entire functionality of the handheld computing unit. Note that parental control may be applied to use of handheld computing units via the extended computing unit by setting the security data for a child's use of the handheld computing unit.

The method continues at step 142 where the processing module generates a security rejection message and causes a graphical representation thereof to be displayed. The method continues at step 144 where the processing module determines whether the response included a retry request. If yes, the method continues at step 146 where the processing module initiates collection of a second level of user security parameter. In this instance, the second level of user security parameter is assumed to be of a higher level than the initial user security parameter. Note that there may be several levels of security for using the handheld computing unit based on the particular use or the particular user. The functioning of the processing module continues at function block 74.

If there is not retry request, the method continues at step 148 where the processing module determines whether the response included an encryption instruction. If not, the processing is done. If, however, an encryption instruction is detected, the method continues at step 150 where the processing module encrypts user data of the handheld computing unit using an encryption key. The encryption key may be stored in secure memory of the handheld computing unit or received via the security response.

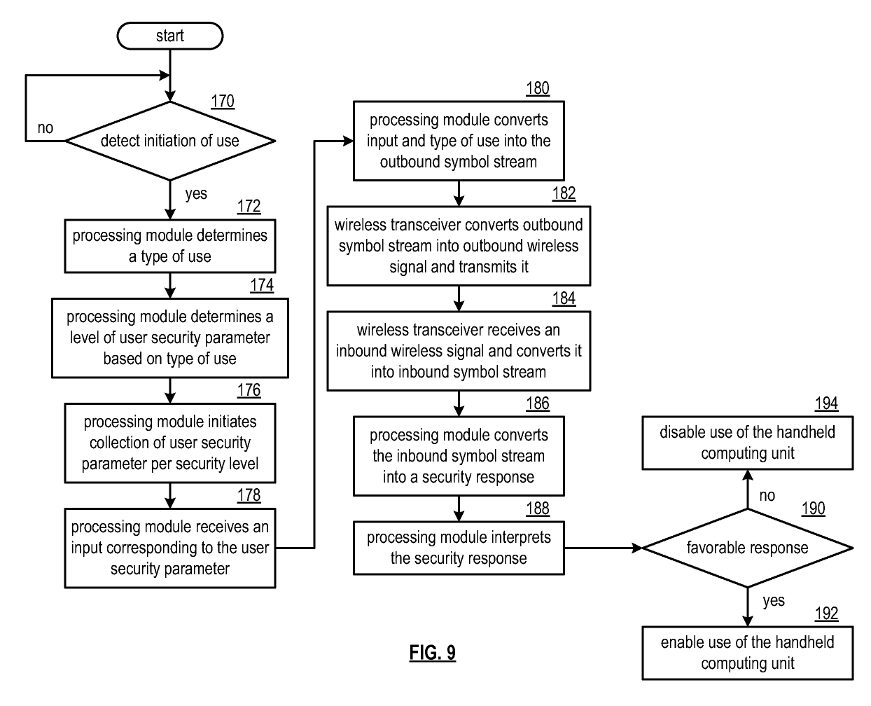

FIG. 8 is a logic diagram of another embodiment of a method for establishing secure use of a handheld computing unit that begins at function block 70 where the processing module detects initiation of use. The method continues at step 152 where the processing module determines a type of use based on the initiation of use (e.g., text message, cell phone call, audio file playback, etc.). The method continues at step 154 where the processing module determines whether the user is a priority use. If yes, the method continues at step 156 where the processing module enables priority use of the handheld computing unit without obtaining the user security parameter. The priority use may be a default priority (e.g., emergency calls) or user specified priorities (e.g., call Mom).

If the use is not a priority use, the method continues at step 158 where the processing module determines a level of user security parameter. For example, a cellular telephone call may have a higher priority than a text message, which may have a higher priority than a digital picture. Alternatively, each use may have its own user security parameter. In either case, the method continues at step 160 where the processing module initiates the collection of the user security parameter in accordance with the level of user security parameter. The functioning of the processing module continues at function block 74.

FIG. 9 is a logic diagram of another embodiment of a method for establishing secure use of a handheld computing unit. The method begins at step 170 where the processing module determines whether initiation of use is detected. This may be done by detecting one or more of initiation of a cellular telephone call, initiation of a text message, initiation of a digital image capture, initiation of audio capture, initiation of a web browser access request, initiation of a data access request, initiation of an audio file playback, initiation of a video file playback, and initiation of a user application.

Once detected, the method continues at step 172 where the processing module determines a type of use based on the initiation of use. The method continues at step 174 where the processing module determines a level of user security parameter based on the type of use. The method continues at step 176 where the processing module initiates collection of a user security parameter in accordance with the level of user security parameter. The method continues at step 178 where the processing module receives an input corresponding to the user security parameter. The method continues at step 180 where the processing module converts the input and the type of use into the outbound symbol stream

The method continues at step 182 where the wireless transceiver converts an outbound symbol stream into an outbound wireless signal and transmits the outbound wireless signal via a wireless communication resource. The method continues at step 184 where the wireless transceiver receives an inbound wireless signal via the wireless communication resource and converts it into an inbound symbol stream.

The method continues at step 186 where the processing module converts the inbound symbol stream into a security response. The method continues at step 188 where the processing module interprets the security response. The method continues at step 190 where the processing module determines whether the security response is favorable. When the security response is favorable, the method continues at step 192 where the processing module enables use of the handheld computing unit. When the security response was not favorable, the method continues at step 194 where the processing module disables use of the handheld computing unit.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A handheld computing unit comprises:
a wireless transceiver coupled to:
convert an outbound symbol stream into an outbound wireless signal;
transmit the outbound wireless signal via a wireless communication resource;
receive an inbound wireless signal via the wireless communication resource; and
convert an inbound wireless signal into an inbound symbol stream; and
a processing module coupled to:
detect initiation of use of the handheld computing unit;
when the initiation of use is detected:
initiate collection of a user security parameter;
receive an input corresponding to the user security parameter;
convert the input into the outbound symbol stream;
convert the inbound symbol stream into a security response;
interpret the security response; and
when the security response is favorable, enable use of the handheld computing unit.

2. The handheld computing unit of claim 1, wherein the processing module initiates the collection of the user security parameter by one of:
automatically capturing the user security parameter upon detection of the initiation of use; and
providing a graphical user request for the user security parameter.

3. The handheld computing unit of claim 1, wherein the user security parameter comprises at least one of:
a password;
a video image;
a finger print;
voice sample; and
security phrase.

4. The handheld computing unit of claim 1 further comprises:
the processing module coupled to generate a request message to establish access to the wireless communication resource upon detection of the initiation of use; and
the wireless transceiver couple to convert the request message into a wireless request signal and to transmit the wireless request signal.

5. The handheld computing unit of claim 4, wherein the request message comprises at least one of:
a cellular telephone call to an extension computing unit;
a cellular telephone call to a security repository;
a wireless area network access message to the extension computing unit; and
a wireless area network access message to the security repository.

6. The handheld computing unit of claim 1 further comprises the processing module coupled to, when the security response is not favorable:
disable the use of the handheld computing unit; and
generate a security rejection message; or
initiate collection of a second level user security parameter.

7. The handheld computing unit of claim 1 further comprises the processing module coupled to:
determine a type of use based on the initiation of use; and
when the type of use is a priority use, enable the handheld computing for the priority use.

8. The handheld computing unit of claim 1 further comprises the processing module coupled to:
determine a type of use based on the initiation of use;
based on the type of use, determine a level of user security parameter; and
initiate the collection of the user security parameter in accordance with the level of user security parameter.

9. The handheld computing unit of claim 1 further comprises the processing module coupled to, when the security response is not favorable:
receive an encryption instruction; and
encrypt user data of the handheld computing unit using an encryption key.

10. The handheld computing unit of claim 1 further comprises the processing module coupled to detect initiation of use comprises at least one of:
detect initiation of a cellular telephone call;
detect initiation of a text message;
detect initiation of a digital image capture;
detect initiation of audio capture;
detect initiation of a web browser access request;
detect initiation of a data access request;
detect initiation of an audio file playback;
detect initiation of a video file playback; and
detect initiation of a user application.

11. The handheld computing unit of claim 1 further comprises at least one integrated circuit to support the wireless transceiver and the processing module.

12. A handheld computing unit comprises:
a wireless transceiver coupled to:
convert an outbound symbol stream into an outbound wireless signal;
transmit the outbound wireless signal via a wireless communication resource;
receive an inbound wireless signal via the wireless communication resource; and
convert an inbound wireless signal into an inbound symbol stream; and
a processing module coupled to:
detect initiation of use of the handheld computing unit;
when the initiation of use is detected:
determine a type of use based on the initiation of use;
based on the type of use, determine a level of user security parameter;
initiate collection of a user security parameter in accordance with the level of user security parameter;
receive an input corresponding to the user security parameter;
convert the input and the type of use into the outbound symbol stream;
convert the inbound symbol stream into a security response;
interpret the security response; and
when the security response is favorable, enable use of the handheld computing unit.

13. The handheld computing unit of claim 12, wherein the processing module initiates the collection of the user security parameter by one of:
automatically capturing the user security parameter upon detection of the initiation of use and the type of use; and
providing a graphical user request for the user security parameter.

14. The handheld computing unit of claim 12 further comprises:
the processing module coupled to generate a request message to establish access to the wireless communication resource upon detection of the initiation of use; and
the wireless transceiver couple to convert the request message into a wireless request signal and to transmit the wireless request signal.

15. The handheld computing unit of claim 14, wherein the request message comprises at least one of:
a cellular telephone call to an extension computing unit;
a cellular telephone call to a security repository;
a wireless area network access message to the extension computing unit; and
a wireless area network access message to the security repository.

16. The handheld computing unit of claim 12 further comprises the processing module coupled to, when the security response is not favorable:
disable the use of the handheld computing unit; and
generate a security rejection message; or
initiate collection of a second level user security parameter.

17. The handheld computing unit of claim 12 further comprises the processing module coupled to, when the security response is not favorable:
receive an encryption instruction; and
encrypt user data of the handheld computing unit using an encryption key.

18. The handheld computing unit of claim 1 further comprises the processing module coupled to detect initiation of use comprises at least one of:
detect initiation of a cellular telephone call;
detect initiation of a text message;
detect initiation of a digital image capture;
detect initiation of audio capture;
detect initiation of a web browser access request;
detect initiation of a data access request;
detect initiation of an audio file playback;
detect initiation of a video file playback; and
detect initiation of a user application.

19. The handheld computing unit of claim 12 further comprises at least one integrated circuit to support the wireless transceiver and the processing module.

20. An extension computing unit comprises:
a network access module coupled to:
receive an inbound network message;
convert the inbound network message into a user security parameter;
convert an affirmative security response into an outbound network message; and
transmit the outbound network message; and
a processing module coupled to:
detect identity of a handheld computing unit initiating the inbound network message;
retrieve security data of the handheld computing unit to produced retrieved security data;
compare the user security parameter with the retrieved security data; and
when the user security parameter compares favorably with the retrieved security data, generate the affirmative security response.

21. The extension computing unit of claim 20, wherein the user security parameter comprises at least one of:
a password;
a video image;
a finger print;
voice sample; and
security phrase.

22. The extension computing unit of claim 20 further comprises:
the network access module coupled to convert the inbound network message into the user security parameter and a type of use; and
the processing module coupled to retrieve the security data of the handheld computing unit based on the type of use.

23. The extension computing unit of claim 20 further comprises:
the processing module coupled to, when the user security parameter compares unfavorably with the retrieved security data, generate an encryption command such that user data of the handheld computing unit is encrypted.
